(19) United States
(12) Patent Application Publication
(10) Pub. No.: US 2009/0158167 A1
(43) Pub. Date: Jun. 18, 2009

(54) SYSTEM FOR CUSTOMIZING MENU OF ELECTRONIC DEVICE AND METHOD THEREOF

(75) Inventors: WEI-JEN WANG, Tu-Cheng (TW); SHIH-PAO CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/193,767

(22) Filed: Aug. 19, 2008

(30) Foreign Application Priority Data
Dec. 17, 2007 (CN) 200710203139.6

(51) Int. Cl. G06F 3/048

(52) U.S. Cl. 715/745

(57) ABSTRACT

A method for customizing a menu of an electronic device is disclosed. First, various menu options are selected. Frequency of use values of the selected menu options is recorded and values thereof archived for a predetermined time. The amount of the menu options displayed corresponding to the frequency is prioritized. Sizes of the menu options according to the frequency are set. The priority of the menu options based on frequency of use is displayed. The displayed menu options are dynamically reorganized according to the records when the predetermined period of time has expired or the records of the selected menu options exceed a predetermined value.

### BACKGROUND

1. Technical Field

The present invention relates to menu management systems and, particularly, to a system for customizing a menu of an electronic device and a method thereof.

2. Description of the Related Art

Electronic devices featuring multiple functions can have complicated menus for operating the devices, which deviates from the level of simplicity users expect in using them. For example, a user might have to go through several menu levels to select a single option. Additionally, the complexity of the menus makes it hard for users to get familiar with the menus quickly.

Therefore, it is desirable to provide a system for customizing a menu of an electronic device and a method thereof which can overcome the described limitations.

### SUMMARY

A method for customizing a menu of an electronic device is disclosed. First, various menu options are selected. Frequency of use values of the selected menu options is recorded and values thereof archived for a predetermined time. The amount of the menu options displayed corresponding to the frequency is prioritized. Sizes of the menu options according to the frequency are set. The priority of the menu options based on frequency of use is displayed. The displayed menu options are dynamically reorganized according to the records when the predetermined period of time has expired or the records of the selected menu options exceed a predetermined value.

### BRIEF DESCRIPTION OF THE DRAWINGS

FIG. 1 is a block diagram of a system for customizing a menu of an electronic device, according to a first exemplary embodiment.

FIG. 2 shows an example of an option display by the system of FIG. 1.

FIG. 3 shows another example of an option display by the system of FIG. 1.

FIG. 4 is a flowchart of a method for customizing a menu of an electronic device in accordance with a second exemplary embodiment.

### DETAILED DESCRIPTION OF EMBODIMENTS

Embodiments of the present system and method will be described in detail below with reference to the drawings. In the following described embodiments, the system is applied to an electronic device such as a camera.

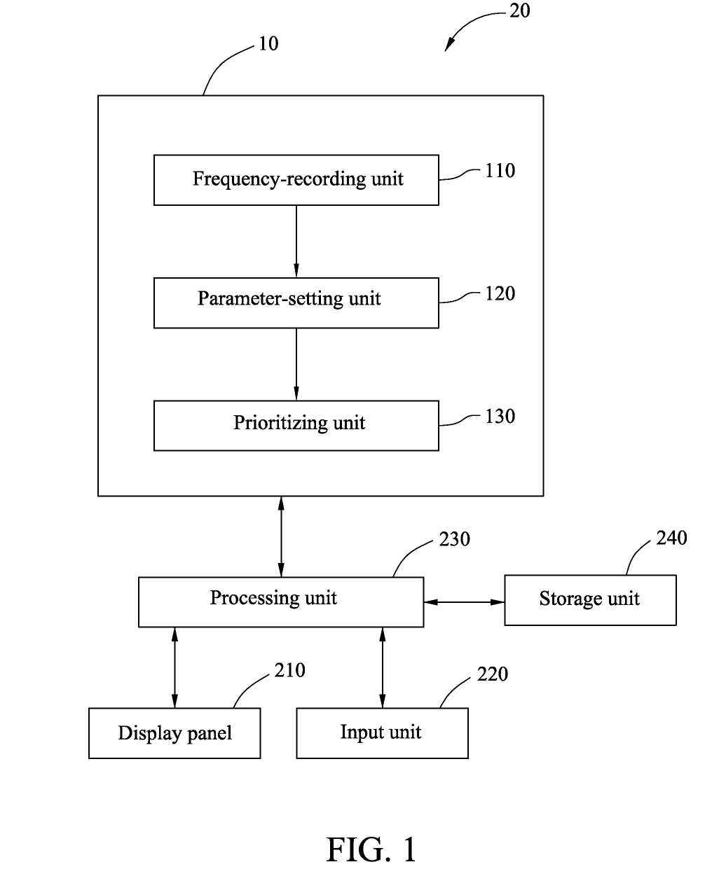

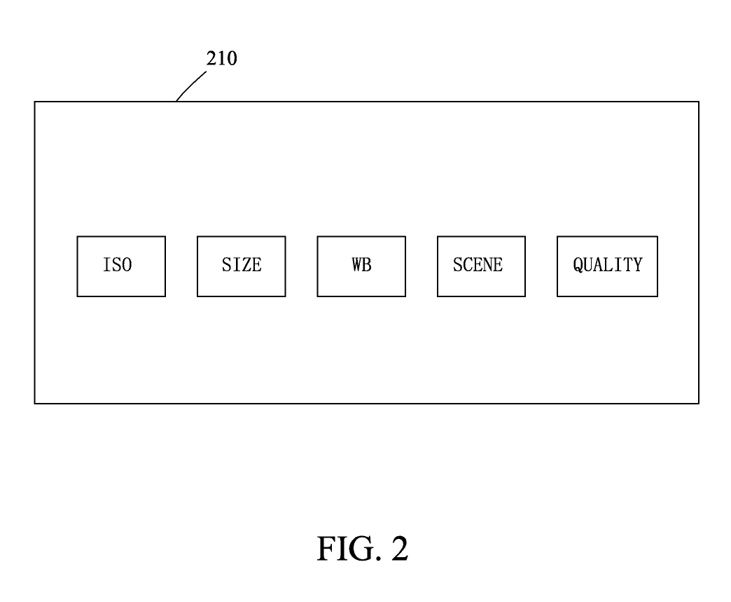

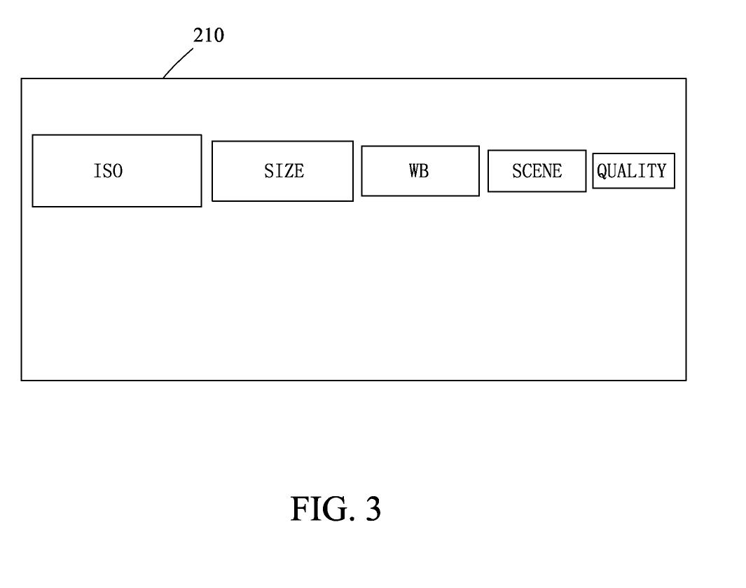

Referring to FIG. 1, a system 10 for customizing a menu of an electronic device 20, according to a first exemplary embodiment, is disclosed. The electronic device 20 includes a display panel 210, an input unit 220, a processing unit 230, and a storage unit 240. The display panel 210 such as a liquid crystal display (LCD) panel is configured for displaying the menu (shown in FIGS. 2-3). The input unit 220 is configured for receiving user selections of menu options. The processing unit 230 is configured for activating functions corresponding to the selected menu options. The storage unit 240, such as a removable memory card or a static random access memory (SRAM), is configured for storing statistical use records.

The system 10 includes a frequency-recording unit 110, a parameter-setting unit 120, and a prioritizing unit 130.

The frequency-recording unit 110 is configured for recording frequency of use of menu options and increasing the frequency of use by a specific value to a specific menu option when it is selected. The specific value can be an integer. In this embodiment, the specific value may be 1. Moreover, if the frequency of use of a menu option exceeds a predetermined value in the frequency-recording unit 110, frequency of use is increased by 1 accordingly.

The parameter-setting unit 120 is configured for setting a predetermined frequency of use value for each menu option. The value is set by manufacturer or user. In this embodiment, the value is preset during manufacturer of the electronic device 20, and frequency of use value for the menu option “SIZE” can be set, for example, as 10.

The parameter-setting unit 120 also sets how many high ranking-menu options are displayed on the display panel 210, and sizes of high ranking-menu options. Increased frequency of use increases size of the menu option. In this embodiment, the top five menu options are preset during manufacture, but can, alternatively, be set by a user.

The prioritizing unit 130 dynamically reorganizes menu options by frequency of use when a predetermined time has expired or records of the selected menu options exceed a predetermined value, calculated by algorithms such as selection sort, insertion sort, bubble sort, or other. In this embodiment, the bubble sort algorithm is employed. The prioritizing unit 130 can rank all of the menu options including main menu options and submenu options, or rank menu options and submenu options respectively. In this embodiment, the former method is used.

Referring to FIG. 2, in an example, the top five menu options are “ISO,” “SIZE,” “WB,” “SCENE,” and “QUALITY”. They respectively represent “camera sensor sensitivity to light,” “extent of an image taken from the camera,” “color correction corresponding to related amounts of red, green, blue primary colors in the image,” “the best exposure and settings for each scene,” “the higher the quality the more pixels used.” The top five menu options are those frequently used and ranked higher than other menu options. In this embodiment, the top five menu options are the same size and display the corresponding icons in order on the display panel 210.

Referring to FIG. 3, in another example, the top five menu options are displayed on the display panel 210 of FIG. 1. The displayed menu options of FIG. 3 are similar to the displayed menu options of FIG. 2, differing only in that the menu options displayed are of different sizes according to the frequency of use, whereby the largest item displayed is the menu option with the highest frequency of use value and, accordingly, the smallest displayed fifth most frequently used menu option. In this embodiment, while the top five menu options are ranked in order by their frequency of use values, it should be understood that the menu options of FIG. 3 are not limited thereto and can be displayed out of order on the display panel 210.

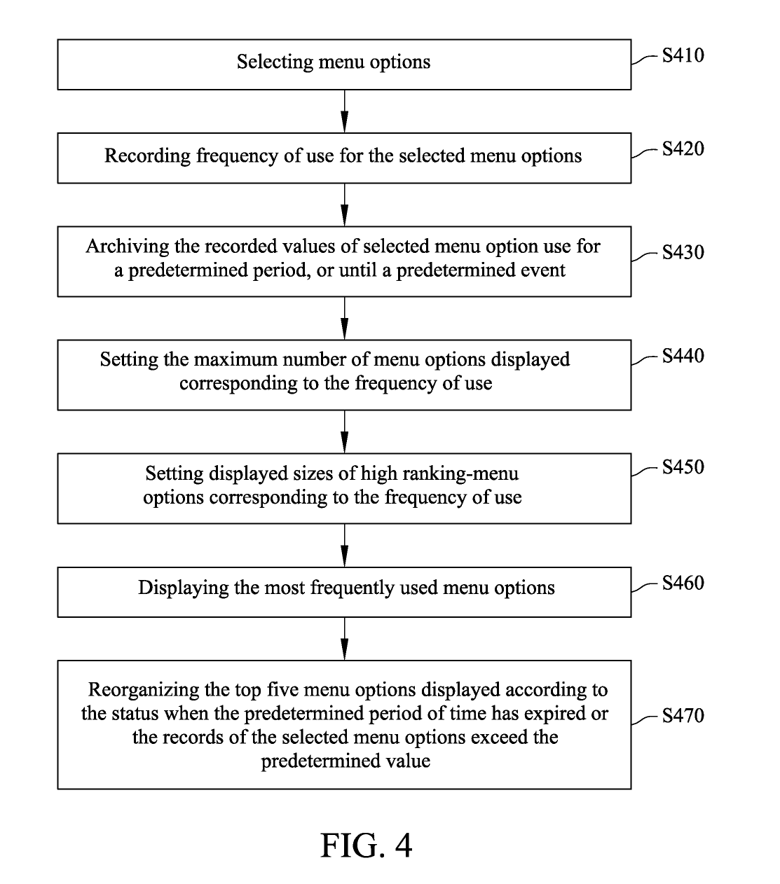

Referring to FIG. 4, a method of customizing the menu of the electronic device includes steps 410˜470.

In step 410, menu options are selected. In this embodiment, the menu options are selected in response to the input unit 230.

In step 420, frequency of use for the selected menu options is recorded. In this embodiment, the frequency of use for the selected menu options is recorded by the frequency-recording unit 110.

In step 430, the recorded values of selected menu option use for a predetermined period, or until a predetermined event, is archived. The predetermined event can include, but is not limited to, recorded use frequencies reaching a predetermined number or an event or state occurring, such as power-on. It is appreciated that various recorded values of menu selections can be archived and stored by the storage unit 240.

In step 440, the maximum number of menu options displayed corresponding to frequency of use is set. In this embodiment, the maximum is set to five.

In step 450, displayed sizes of high ranking-menu options corresponding to the frequency of use are set. In this embodiment, more frequently used menu options are displayed in a larger size than less frequently used ones.

In step 460, the most frequently used menu options are displayed. In this embodiment, the top five menu options are displayed by a display panel 210.

In step 470, the top five menu options displayed on the display panel 210 are reorganized according to the status when the predetermined period of time has expired or the records of the selected menu options exceed the predetermined value.

Therefore, the present system for customizing the menu of an electronic device simplifies navigation by allowing selection from a list of frequently used options and customization of the list to order the display.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A method for customizing a menu of an electronic device, comprising:
selecting various menu options;
recording frequency of use values of the selected menu options;
archiving the recorded values for a predetermined time;
ordering the number of menu options corresponding to the frequency of use values;
setting displayed sizes of the menu options corresponding to the frequency of use values;
displaying the menu options based on frequency of use values; and
dynamically reorganizing the displayed menu options according to the recorded values when the predetermined period of time has expired or the records of the selected menu options exceed a predetermined quantity.

2. The method as claimed in claim 1, wherein the menu options are displayed in order corresponding to the frequency of use values.

3. The method as claimed in claim 1, wherein the size of each menu option display corresponds to the frequency of use values thereof.

4. An electronic device utilizing a customizable menu, comprising:
a display panel capable of displaying menu options;
an input unit capable of being used to select menu options displayed on the display panel;
a system capable of recording frequency of use values for the selected menu options and ordering the menu options corresponding to the frequency of use values; and
a storage unit capable of archiving the recorded values for a predetermined time.

5. The electronic device as claimed in claim 4, wherein the system is further capable of determining the priority of the menu options to be displayed based on frequency of use values thereof.

6. The electronic device as claimed in claim 5, wherein the number of menu options displayed on the display panel corresponding to frequency of use values is five.

7. The electronic device as claimed in claim 5, wherein the display panel is a liquid crystal display touch panel.

8. The electronic device as claimed in claim 4, wherein the storage unit is a removable memory card.

9. The electronic device as claimed in claim 4, wherein the system comprises a frequency-recording unit, a parameter-setting unit, and a prioritizing unit.

10. The electronic device as claimed in claim 9, wherein the frequency-recording unit is configured for recording frequency of use values of the selected menu options.

11. The electronic device as claimed in claim 9, wherein the parameter-setting unit is configured for ordering the displayed menu options and setting the displayed sizes of the menu options according to corresponding to frequency of use values.

12. The electronic device as claimed in claim 9, wherein the prioritizing unit is configured for dynamically reorganizing the menu options by frequency of use values when a predetermined time has expired.

13. The electronic device as claimed in claim 9, wherein the prioritizing unit is configured for dynamically ordering the priority of the menu options by frequency of use values when the records of the selected menu options exceed a predetermined value.
